(19) United States
(12) Patent Application Publication
(10) Pub. No.: US 2003/0054311 A1
(43) Pub. Date: Mar. 20, 2003

(54) Plastoelastomeric polymer and products made therefrom

(76) Inventor: Sebastian V. Kanakkanatt, Akron, OH (US)

Correspondence Address: EMERSON & SKERIOTIS, Fourteenth Floor, One Cascade Plaza, Akron, OH, 44308, US

(21) Appl. No.: 10/224,986

(22) Filed: Aug. 21, 2002

Related U.S. Application Data
(63) Continuation-in-part of application No. 09/397,971, filed on Sep. 16, 1999, now Pat. No. 6,461,392.
(60) Provisional application No. 60/100,668, filed on Sep. 16, 1998.

(51) Int. Cl. F23D 3/16; C08L 23/00; C08K 3/00; C08J 3/00; C08L 1/00; C10L 7/00; C11C 5/00; C10L 5/00

(52) U.S. Cl. 431/288; 44/275; 524/525; 524/528

(57) ABSTRACT

A clear plasto-elastomeric material comprising a thermoplastic, an elastomer or a copolymer or a blend thereof, mineral or vegetable oil, or a mixture thereof, and a fire retarding agent, is disclosed. This material has a combination of resiliency and shock absorption and is exceptionally hydro-slimy. Footwear made of this material has a high degree of comfort and shock absorption, slides made with the lining of this material are more efficient than water slides, and candles made with this material are freestanding, unbreakable, and have a very long burning time. The candles have been enhanced with photochromic, thermochromic, iridescent, fluorescent, and phosphorescent materials and with combinations thereof.

This application claims priority to an U.S. Provisional patent application Serial No. 60/100,668, entitled UNBREAKABLE CANDLE, filed on Sep. 16, 1998 and U.S. application Ser. No. 09/397,971, entitled CLEAR PLASTO-ELASTOMERIC MATERIAL AND PRODUCTS MADE THEREFROM, filed on Sep. 16, 1999.

### I. FIELD OF THE INVENTION

This invention relates to the art of plastics and elastomers, and more particularly to the art of a clear, resilient plasto-elastomeric material.

### II. BACKGROUND OF THE INVENTION

Soft gel materials used in container candles have been reported in U.S. Pat. No. 5,789,089, by Elasamatory. This material is unsuitable for use as a freestanding candle, or in shoe soles, or in any of the other uses for which the present invention is ideal.

A characteristic transparent candle has been disclosed is U.S. Pat. No. 3,819,342 (the '342 patent). This candle comprises a thermoplastic polyamide resin and a flammable solvent selected from the group consisting of unsaturated fatty acids with polyhydric alcohols, and mixtures thereof. This candle suffers from the drawback of potential flaring, resulting from the separation of oil from the candle forming a top layer.

U.S. Pat. No. 3,615,389 (“the '389 patent”), discloses another clear candle that is chemically similar to the device of the '342 patent. The composition comprises a thermoplastic polyamide resin formed from linoleic acid, polymerized with a polyamide alkolamide or alkanol, and stearic acid. This composition allegedly alleviates syneresis. But U.S. Pat. No. 5,578,089 claims to have tested the above compositions and found that separation was a consistent problem in '389 and '342 candles. The '389 patent also claims the optional addition of ionic surface agents that prevent “blooming” or fogging, which result in the loss of transparency. Although this may be helpful, it does not eliminate cloudiness.

U.S. Pat. No. 3,645,705 (“the '705 patent”) discloses a transparent candle material comprising a straight chain aliphatic amide with white mineral oil and alcohol. There is also a methyl ester added for hardness. The '705 patent, however, is similar to the '342 and '389 patents, in that it suffers from the same structural and functional problems.

U.S. Pat. No. 3,741,711 (“the '711 patent) appears to disclose a clear, undyed, and unpigmented wax band “candle.” However, the invention is a reusable “candle holder” and not a “candle.”

### III. SUMMARY OF THE INVENTION

This invention relates to a plasto-elastomeric material comprising two or more of, but not limited to, the following: (a) thermoplastic; (b) mineral oil; (c) vegetable oil; (d) rubber; (e) thermoplastic olefin; (f) thermoplastic elastomer; (g) copolymer; and (h) blends of two or more of the above. Some of the exceptional properties of this material are the following: (1) Clarity; (2) resiliency; (3) shock absorption; (4) resilio-damping balance; (5) high flash point; (6) burns leaving no ash at high temperatures; and (7) hydro-sliminess not affected by applied pressure.

The above properties, as well as others, render the plasto-elastomeric material of this invention highly applicable for use in the following:

i. Insoles and soles of shoes;

ii. water slide replacement surfaces;

iii. mold making;

iv. unbreakable, free standing candies; and,

v. medical devices such as catheters, tubes in general, flexible implants and the like.

One object of the present invention is to form an unbreakable, transparent, non-flaring, non-blooming candle that burns without coking or dripping.

Another object of the present invention is to exclude the use of polyamides or nitrogen-containing polymers that are known, on burning, to exude hazardous byproducts containing oxides of nitrogen.

Yet another object of the present invention is to produce an extremely slow burning candle. The candle made from the composition of this invention will take more than five times longer to burn the same amount of material with a similar size flame as a known candle.

Still another object of the present invention is to form a candle that is longer than wax-based and polyamide-resin-based candles.

Another object of the present invention is to mold a candle which is either clear, meaning uncolored, or dyed with organic pigments, which maintain the transparency of the candle in the colored state. These pigments are not sensitive to light, nor do they decrease the clarity of the candle, the size of the flame during burning, nor do they cause any flare. The inert nature of the composition in this invention makes it inactive to the dyes or pigments at the elevated temperatures of the molten material.

A further object of the present invention is to prevent age-induced brittleness, which is encountered in wax-based and polyamide-resin-based candles.

Another object of the present invention is to make transparent candle material that does not need a container to hold it, as in the case of presently available gel candles. The candles made from the present composition are freestanding, unbreakable, and free of a container.

One advantage of the present invention is its thermal reversibility. Unlike polyamide-resin-based candles, the composition in the present invention is remeltable and reusable any number of times. This feature of the present invention allows the mixing of color(s), fragrances, etc. before molding as well as after molding and re-melting. This recycling capability minimizes the waste and environmental problem associated with solid waste disposal.

Another advantage of the present invention is the elimination of syneresis/blooming resulting from excessive cross-linking, which is a serious problem in polyamide resin based candles. By eliminating any chemical cross-linking, and minimizing the so-called physical cross-linking, the oil exuding problem is overcome in the present invention.

Yet another advantage of the present invention is that the plasto-elastomeric material has exceptional balance of resilience and damping properties, which makes the material ideal for soles of shoes, rendering a high level of comfort to the wearer.

Still another advantage of the present invention is the high flash point that makes it suitable for use in making clear, free-standing, non-flashing candles, and for use as a high resolution mold polymer in the jewelry industry.

Another advantage of the present invention is that the burning emission, and the solid melting states are all non-toxic as well as nearly soot-free. At high temperatures the composite material leaves no ash, making it ideal for use as a mold polymer. While rubber used as a mold rubber or mold polymer produces toxic emissions when it is burnt from the mold, the plasto-elastomeric material in the present invention, being made of hydrogen and carbon only, creates no toxic fumes during complete combustion.

Yet another advantage of the present invention is that the material has zero friction when two slabs of the material contact each other with a small amount of water between the slabs. The coefficient of friction between the two slabs, with moisture in between, is lower than two Teflon slabs under similar conditions. This ultra low, or zero, friction remains the same no matter what pressure or load is applied to the slab. This unusual feature of the material is referred to as ‘hydro-sliminess.’ This hydro-sliminess of the plasto-elastomer is not thixo-limiting. On the other hand, with greater applied pressure and/or increased load on the top layer, the water-induced slippery property only increases. Thus this property makes it applicable as a surface for slides, similar to the water-slides, with the advantages that the volume of water used is small and the steepness of the sliding slope is drastically decreased.

The above aspects are achieved in accordance with the first aspect of the present invention which is a candle comprising an unbreakable, free-standing, clear body without a container, at least one wick, which may be introduced before the molten mass solidifies or after the candle body is made by a needle threaded with the wick. The body is a clear, strong, free-standing gel comprising 60 to 90 weight % of liquid paraffin wax, mineral oil, vegetable oil, carbowax and combinations thereof, 10 to 40 weight % of thermoplastic elastomers having plastic and elastomeric phases, chemically bonded together, as in Kratons™, manufactured by Shell Chemical Co., or thermoplastic elastomers in which plastic and elastomeric phases are physically blended, as in the case of Santoprene™ manufactured by Advanced Elastomer Systems, or polymeric alloys made by blending selected plastics such as polystyrene, polyethylene, polypropylene, etc. and elastomers such as polybutadiene, cis-poly-isoprene, ethylene-propylene-diene rubber, styrene-butadiene rubber, natural rubber, etc. or combinations thereof.

### IV. DESCRIPTION OF THE PREFERRED EMBODIMENT

The preferred embodiments of the present invention will now be described in greater detail below.

A candle body material is made as follows: 20.1 to 50% of a polymer, which is nitrogen free, thermoplastic, and elastomeric above the glass transition temperature of the rubber phase. This polymer, or polymer system, must have two phases at the operating temperature. That means it will have a plastic phase that has a very high glass transition temperature and the rubbery (clastomeric) phase will have a very low glass transition temperature. This may be realizable in a single polymer that has plastic blocks and elastomeric blocks in a single molecular chain as in block copolymers of the diblock, triblock, or multiblock copolymers. In multi-block copolymers, one type of block is made of monomers such as styrene, which yields the plastic phase, and the other type of block is made of monomers such as butadiene, which yield the elastomeric phase. These blocks are chemically bonded to give the thermoplastic elastomer such as Kratons™, manufactured by Shell Chemical Company. It may also be realizable in a physical blend of the two, namely, the plastic and the elastomer, giving two phases in the blend. The relative proportions of the two will determine which would be the continuous phase and which would be the discrete phase. A relatively higher proportion of the plastic component will give a blend with a plastic continuous phase yielding a thermoplastic elastomer, while a higher relative proportion of the elastomer will give plastic reinforced rubber. These blends are available from Advanced Elastomer Systems and the trade name is Santoprene™.

Another way of making the polymer system for this invention is by melting select plastics, such as polystyrene, and select elastomers, such as polybutadiene, and creating a polymer alloy with the desired properties of a thermoplastic elastomer. The molecular weight of the plastic component may be from 5,000 to 100,000 and that of the elastomeric component may be from 10,000 to 500,000. The alloy may be made in relative proportions of plastic to elastomer from 1:99 to 99:1, the preferred range being from 40:60 to 60:40. The second component of the composition is an oil, extender, or a plasticizer selected from: paraffinic oils, naphthenic oils, carbowaxes, mineral oils, vegetable oils, liquid long chain aliphatic alcohols, liquid long chain aliphatic acids, esters of aliphatic alcohols and acids, plasticizers (other than phthalates), or combinations thereof.

The third ingredient is selected from glycerides of long chain acids, such as lauric acid, myristic acid, or stearic acid. The fourth and additional ingredients are 1) dyes which are temperature stable, light stable, and oxidation stable; 2) thermochromic dyes, which change color with the change of temperature; 3) photochromic dyes, which are sensitive to UV and visible light radiations, resulting in a color change; 4) phosphorescent pigments, which glow in the dark after having been activated by UV or visible light; 5) fluorescent pigments which glow in the day; and 6) scents and fragrances.

This fourth ingredient is preferably selected from, but not limited to, chlorinated paraffins, chlorinated hydrocarbons, and ammonium polyphosphate-4 triaryl phosphates. Fire-retardants are added in extremely low quantities to minimize or eliminate the flaring hazard, without sacrificing the normal burning or transparency of the candle.

Most, if not all, gel candles flare frequently. This is because of the high content of oil, which always blooms to the surface. This oil makes anything that touches the candle greasy and oily. In this invention, the polymer contains a special organic, non-poisonous, fire retardant that drastically minimizes, if not eliminates, the flaring problem. The balanced oil-polymer fire retardant formula, disclosed in this invention, eliminates the threefold problem in gel candles, namely, flaring, oil leaching, and collapsing, all without a container. The specially-made fire-retardant eliminates the flaring hazard without interfering with the normal burning of the candle or reducing the clarity or transparency of the candle.

### EXAMPLE 1

2.1 lbs. of ethylene-nonene copolymer, manufactured by Advanced Elastomer Systems under their tradename, Engage™, 0.01 lb. of chlorinated paraffin manufactured, by Dover Chemicals under the trade name Chlorez™, and 7.9 lbs. of naphthenic oil manufactured by Penreco, under the tradename Drakeol™, are weighed out in an aluminum tray and heated in a preheated oven at 316° F. for 4 hours. At the end of this period the two components are blended and gelled together to form a clear homogenous mass. This homogenous mass is taken out of the oven and cooled at room temperature for about 6 hours. It is now ready for remelting and pouring into candle or other molds.

### EXAMPLE 2

3.0 lbs. of ethylene-butadiene copolymer, manufactured by Shell Oil Company under the tradename Kraton™, 0.01 lb. of Chlorez™, and 7.00 lbs. of paraffinic oil, manufactured by Penreco under the tradename Drakeol™, are weighed out in an aluminum tray and heated in a preheated oven at 296° F. for 4 hours. At the end of this period the two components are blended and gelled together to form a clear homogenous mass. This homogenous mass is taken out of the oven and cooled to the room temperature for about 6 hours. It is now ready for remelting and pouring into the candle or other molds.

### EXAMPLE 3

The product, as in Example 1 or Example 2, is remelted at 250° F. 5 lbs. of the molten material is mixed with 0.052 lb. of a foaming agent and the temperature is raised to 275° F. to start the foaming action. When the foaming agent is completely decomposed, the foamed material is chilled in order to stop the foaming action. Fire retardants, colors, fragrances, and other additives are used for further enhancing the product's properties. This polymer, “Plastomelastomeric Polymer,” as reported in the patent applications with titles “Unbreakable Candle” and “Plastoelastomeric Polymer and Products Made there from,” has several applications stemming from the combinations or severalty of its properties such as a balance between resilience and shock absorption, high value for insulation to heat and electricity, ability to form gel-like consistency to hold combustible fuels such as oils, ability to slip and slide with a thin layer of water, pressure induced adhesiveness, etc., to name a few.

This CIP is to give the wide area of coverage of the polymer constituents used in this invention and to give examples of several applications.

The common ingredients in all grades of Plastoelastomeric Polymer are three: a thermoplastic, a thermoplastic elastomer, and an elastomer as stated in the provisional patent application No. 60/100,668 as well as in the utility patent application Ser. No. 09/397,971.

Examples of thermoplastic elastomers are block copolymers such as Kraton manufactured by Shell Oil Co., Santoprene manufactured by Advanced Elastomer Systems, and Engage manufactured by Dupont Dow Elastomers.

Kraton may be diblock, triblock, mutliblock, or radialblock, but all have only two types of blocks. The monomer units in these blocks may be styrene and butadiene, styrene and isoprene, ethylene and propylene, etc. One type of block is thermoplastic in nature while the other type is elastomeric in nature. At temperatures below the glass transition temperature of the thermoplastic, it is a frozen solid and behaves like cross-link points for the rubbery phase. At temperatures above its Tg, it softens and becomes elastic or rubbery in nature; it blends with the elastomeric blocks and becomes a uniform melt, thus the name “Thermoplastic Elastomer.” All Kraton are essentially, “Diblock,” as defined above, as well as under the section “Definitions.”

The percentage of the thermoplastic and that of the elastomeric blocks will determine the mechanical and dynamic mechanical properties of these polymers; for example, increasing the thermoplastic proportion, the polymer becomes more rigid; increasing the elastomeric proportion, the polymer becomes more resilient or even tacky. Kraton have only a few variations of the percentages of the thermoplastic and of the elastomeric regions. This does not give much room to work with in the broad applications envisaged by the Plastoelastomeric Polymer, which is the present invention.

Santoprenes are blends of a thermoplastic and an elastomer made under high shear conditions resulting in a partially chemical bonding. This polymer blend behaves very similarly to Kraton; i.e., the Santoprene behaves like a cross-linked rubber at temperatures below the glass transition temperature of its plastic component. One such thermoplastic component is polypropylene, and one type of elastomeric component in one grade of Santoprene is EPDM, which is a terpolymer having the monomers ethylene, propylene, and a diene in a random distribution of these monomer units. Santoprenes behave like a thermoplastic rubber, although little or no chemical bond exists between the polypropylene and EPDM. Santoprenes are manufactured by Advanced Elastomer Systems.

Engages are copolymers of ethylene and other olefins such as 1-octene in a random distribution. There are no blocks of monomer units in an extent to make it a diblock thermoplastic elastomer. It is thus described as an elastomer, manufactured by Dupont Dow Elastomers. Engage 8400 is a clear polymer, elastomeric in behavior at room temperature. This polymer is also a constituent in the present invention.

Definitions

1. Polymer. A large number of monomer units of one or more types are linked together chemically to form a large molecule which may be linear, branched, radial, star type, ring type, etc.

2. Copolymer. A polymer made up of two types of monomer units.

3. Terpolymer. A polymer made up of three types of monomer units.

4. Monomer. A chemical entity which has functional groups such as double or triple bonds, alcohol, acid, amine groups, etc., which can link with each other or with other units to form a polymer.

5. Alternating Copolymer. A copolymer made of two types of monomer units in an alternating sequence.

6. Random Copolymer. A copolymer made of two monomers whose sequence distribution does not follow any order.

7. Block. A large number of monomer units of the same kind or units made of two or more monomer units of different kinds.

8. Monoblock Polymer. A polymer made of one type of monomer or a copolymer made of similar repeat units of the same kind but each unit made of two or more different types of monomers.

9. Diblock Copolymer. A copolymer made up of two types of monomer units or repeat units containing two or more types of monomers in each repeat unit forming blocks of such monomer units or such repeat units. A diblock copolymer may be linear, branched, radial, or ring in which there may be any number of blocks of repeat units; as long as there are no more than two types of repeat units, it still is a diblock. For example: AB, ABA, SEPS, SEBS, SIS etc.

The following descriptions will clarify the terms used in this document although different connotations are associated with these terms and are found elsewhere. Since accuracy of communication is essential in an invention, the following definitions are included to avoid confusion and misinterpretation.

AB type Kraton in which the blocks of A type repeat units and B type repeat units exist in a linear, radial, branched, or ring form.

ABA type Kraton in which blocks of A type repeat units and B type repeat units exist in a linear, radial, branched, or ring form.

SEPS type Kraton in which one type of repeat unit is styrene; the other type of repeat unit is ethylene-propylene. Although there are three types of monomers in this block copolymer, since the ethylene-propylene unit repeats itself as one unit, it counts as only one type of unit. Thus, this is a diblock copolymer. Because there are no blocks of ethylene units or blocks of propylene units, EP or ethylene-propylene units actually derived from isoprene units by hydrogeneration of SIS or styrene-isoprene-styrene, which strictly has only two types of monomer units and thus is a diblock copolymer.

Triblock Terpolymer. A terpolymer made up of blocks of monomer units or repeat units of three different types in a linear, branched, ring, radial, etc. molecule. Example: ABC type in which A stands for a block of A type monomer or repeat unit, B stands for a block of B type monomer or repeat unit, and C stands for a block of C type monomer unit or repeat unit. There are not many or any Kraton to fit in this category, although some diblock Kraton are called “triblock” by loose definition. Most if not all Kraton are diblock.

Most if not all Santoprenes are diblock. There are not large enough ethylene units, propylene units, or diene units in EPDM, than could fit into the category of triblock, tetrablock, etc. There may be a number of blocks of the same type of monomer, since it is not the number of blocks but it is the number of types of blocks that makes a polymer triblock, tetrablock, or polyblock. There are few triblock, tetrablock, or polyblock polymers.

Most if not all Engages are monoblock, but are copolymers since they made are up of ethylene units and octene units, (and possibly other olefin units). There are no blocks of ethylene of significant length to make a block of ethylene units; the same is true with octene units or other olefin units. Thus it is a monoblock copolymer.

Thermoplastics. These are monoblocks; i.e., made up of the same monomer units or repeat units. Examples are polyethylene, polypropylene, polystyrene, ethylene propylene, copolymer, etc. This can be heat softened and cooled any number of times; thus, the name thermoplastic.

Elastomer. These are monoblocks; i.e., made up of one type of monomer or repeat units. Examples are polyisoprene, polybutadiene, ethylene-propylene rubber, EPDM, etc. These are rubber-like at room temperature; when cooled below its Tg, it freezes to become brittle or plastic-like.

The present invention is made up of varying proportions of at least three main ingredients of polymers and at least one ingredient that is oil, oil-like, or butter-like hydrocarbon. The polymer ingredients are, but not limited to, a thermoplastic, a thermoplastic elastomer, and an elastomer.

Thermoplastic. This includes any hydrocarbon polymer which has thermoplastic behavior; i.e., hard at room temperature, soft at higher temperatures. When a thermoplastic is heated, it undergoes softening, not melting, like crystalline materials do, over a range of temperatures. Above its Tg, it has elastomeric properties. When cooled, it reverts back to the solid plastic. Examples are: polystyrene, polyethylene, polypropylene, and ethylene-propylene copolymer. Although polyamides and some polyurethanes are thermoplastics, these are not used in candle grades of this invention, since they contain nitrogen atoms in their molecules, which give off oxides or nitrogen on combustion. However, they are included in formulations made for non-candle applications.

Thermoplastic Elastomer. This most often is a copolymer; it may be monoblock, diblock, or another type. It has both thermoplastic components as well as elastomeric components. Thus, it can behave like a thermoplastic as well as an elastomer. These thermoplastic and elastomeric components are chemically bonded during the polymerization process or partially chemically bonded during blending under high shear and/or at high temperatures. The percentages of these two components determine the hardness, softness, elasticity, tackiness, etc. of the secondary products made using these polymers. Since these percentages are fixed in a grade of Kraton or Santoprene, the only way to alter the physical mechanical properties of the secondary products is to alter this proportion by adding monoblocks, which are thermoplastic or elastomeric in nature.

Thermoplastic elastomers useful in incorporating in Plastoelastomeric Polymers are, but not limited to the following:

1. Many Santoprenes manufactured by Advanced Elastomer Systems. For making clear, freestanding candles, Santoprene grades in the form of powder or sheets, which are white, colorless, or nearly colorless. Colored grades can be used in small quantities in making colored candles and other articles such as heel cups, insoles, and in adhesives.

2. Many grades of Kraton, diblock and optionally triblock in a linear, branchial, radial, or ring structure, particularly those Kraton which have numbers G1650, G1651, G1652, G1701X, G1702X, G1726X, G1654, functionalized Kraton polymers such as FG1901X, FG1962X & 1657, and oil extended Kraton such as IR303, G1650, G1651 and G1654 are preferred.

3. Many grades of Engage manufactured by Dupont Dow Elastomers. 8150, 8100, 8840, 8200, 8411, 8400 etc.; 8400 is preferred.

Elastomers incorporated in the Plastoelastomeric Polymer include, but are not limited to, polybutadiene, natural rubber, polyisoprene, EPDM, EPR, and Engage.

The addition of thermoplastic to the thermoplastic elastomer increases the percentages of thermoplastic in the blend. Thus, without having to change the relative proportions of a selected thermoplastic elastomer, the inclusion of this monoblock thermoplastic makes it possible to control the physical properties of the resulting blend, especially increasing the hardness without increasing the proportion of thermoplastic elastomer. In the same manner, including a monoblock elastomer increases the proportion of elastomer in the blend. Resilient properties inherent in elastomers enhance that property in the blend.

Thus, the blend of a thermoplastic, a thermoplastic elastomer, and an clastomer offers limitless variations of properties to give a broad spectrum of polymer blends and Plastoelastomeric Polymers, which could not previously be achieved by increasing the Kraton only or by decreasing the proportion of oil alone.

This invention is not limited to freestanding candles only; but it is for other products such as heel cups, shoe soles, prosthetics, and the like.

Patent '089 teaches making a gel using a diblock and triblock Kraton polymer and various proportions of oils. Candles made from these gels are contained in a jar or other containers. Patent '089 does not claim a freestanding candle, but clearly claims the use of a diblock and triblock in the formula.

Patent '694 teaches making a gel using only a triblock Kraton polymer, optionally a diblock Kraton polymer. The candle made from this gel is contained in a jar. It does not claim a freestanding gel candle.

When CIP '329 came out, however, an addition to claim No. 2 of patent '694 is made and claim No. 17 in patent '329 includes “in ajar or mold.” This does not clearly state a claim for a freestanding candle.

A freestanding candle is hard enough to stand alone without a container; i.e., not in contact with a container. A candle in a mold is supported by and in contact with the mold and it is not standing alone.

Hence, the provisional patent application No. 60/100,668 as well as the utility patent, application Ser. No. 09/397,971 and this “Continuation in Progress” application have the basic claim of the concept of a stand-alone polymer candle. No patent hitherto made public has this claim. The basic ingredients; namely at least one thermoplastic, thermoplastic elastomer, and an elastomer to form a Plastoelastomeric Polymer using varying proportions of oil is the crux of this invention; no patent hitherto made public claims all three ingredients in the same material.

By varying proportions of these ingredients, in addition to varying the solid content, a number of grades of Plastoelastomeric Polymers are made.

| Grade | Polymer Content |
|---|---|
| Gel in a container | 3 to 10% |
| Freestanding candle, etc. | 11 to 20% |
| Insoles, heel cups, etc. | 21 to 50% |
| Moldable, extrudables | 51 to 100% |

Since this CIP is focusing on the candle grade, the solid content is an important criterion to make it freestanding. By increasing the polymer content, thereby decreasing the oil content, the availability of the oil for the wick to burn well is decreased. Thus, the candle will have a weak flame. If the wick size is increased to remedy the situation, a flaring candles results. However, addition of fragrances to the candle grade lowers the polymer content and the grade can be lowered by the addition of fragranced oils.

Most fragrances have a low flash point, and all fragrances, especially polar ones, are not compatible with the hydrophobic polymer blend. In order to incorporate a low flash point fragrance, it must first be mixed with high flash point oil. Since viscosity, boiling point, and flash point are related to one another, selection of a high viscosity, high boiling point oil gives high flash point oil. A mixture of fragrance oil having a flash point of 200° F. and high flash point (FP) oil with a FP of 500° F. in the ratio 1:4 should give an overall flash point of 440° F., which is a safe flash point of the fragrance oil mixture. That means in order to incorporate 5% fragrance, 25% fragrance oil mixture needs to be added to the polymer blend. So, it is important to start with or uses a high polymer content gel. Thus, using a gel with 20% polymer content for the addition of 25% fragrance oil mixture, the solid content of the candle will drop to 16%; on the other hand, starting with a gel of polymer content 16%, adding 25% fragrance oil mixture to 12.8% solid content. A solid content below 13% may free-stand for a period of time, but it will collapse with time in a warm room or climate.

Moreover, high polymer content gel costs less to ship. It is much easier to lower the polymer content by adding oil to the molten gel than to raise the polymer content by adding polymer. Also, low polymer content gel costs more to ship.

Below is given a table to adjust the flash point and adjust the solid content using the oil or fragrance oil mixture.

TABLE I

| | | | | Overall |
|---|---|---|---|---|
| F.P. of | Percent | F.P. of | Percent | F.P. of the |
| Fragrance | Fragrance | Oil Added | Oil | Mixture |
| 150° F. | 28.5 | 500° F. | 71.5% | 400° F. |
| 200° F. | 33% | 500° F. | 67.0% | 400° F. |
| 250° F. | 40% | 500° F. | 60.0% | 400° F. |

TABLE II
To determine the percentage of fragrance oil mixture to be added to the
plastoelastomeric blend to arrive at an optimum polymer content
of 13%, 14%, or 15%.

| Starting | Percentage of | Polymer | Final (K-B) |
|---|---|---|---|
| Polymer Content | Oil to be Added | Plasto | Polymer Content |
| 100.0 | 87.00 | 13.00 | 13 |
| 80.0 | 83.75 | 16.25 | 13 |
| 50.0 | 74.00 | 26.00 | 13 |
| 30.0 | 56.70 | 43.30 | 13 |
| 20.0 | 35.00 | 65.00 | 13 |
| 17.0 | 24.50 | 76.50 | 13 |
| 15.0 | 13.30 | 86.70 | 13 |
| 14.0 | 7.20 | 92.80 | 13 |
| 13.5 | 3.70 | 96.30 | 13 |
| 13.0 | 0.00 | 100.00 | 13 |

To Arrive at a Target 13% or K-13

| Kalene | % of Kalene | % of Oil |
|---|---|---|
| Polymer | To be Taken | To be Added |
| K-100 | 13.00 | 87.00 |
| K-80 | 16.25 | 83.75 |
| K-50 | 26.00 | 74.00 |
| K-30 | 43.30 | 56.70 |
| K-20 | 65.00 | 35.00 |
| K-17 | 76.50 | 24.50 |
| K-15 | 86.70 | 13.30 |
| K-14 | 92.80 | 7.20 |
| K-13.5 | 96.30 | 3.70 |
| K-13.0 | 100.00 | 0.00 |

If one starts with K-17 and adds 25% fragrance/oil mixture, the resulting polymer gel will have less than 13% polymer content. Thus, one gets flexibility to add fragrance/oil mixture having an overall flash point of 400° F. of higher, if the starting Kalene has higher polymer content. This is a distinct departure from what patents '329 and '694 teach. Patent '694 teaches to use Drakeol-7, which has a flash point of 350° F.; most, if not all, examples give candles that flare even without the addition of fragrance, and addition of fragrance worsens the situation because the overall flash point drops to a more dangerous level.

The present invention solves the problem; first, by the use of oil with a high flash point in making the Kalene; second, a eutectic boiling mixture of oils is made to get an overall flash point that is high enough (˜400° F.) to be safe to use in candles. Third, fragrance is mixed with high flash point oil to give an overall high flash point. Fourth, starting with a Kalene grade with higher polymer content than required in candles so that there is flexibility to add enough fragrance/oil mixture without going below the grade needed for free-standing candles (11% to 15.5%).

The following table gives an approximate level of polymer (solid) content for use of Kalene for a variety of applications.

TABLE III

| Application | % Solid Content | % Fragrance/Oil |
|---|---|---|
| Liquid gel | 1-4 | -0- |
| Container gel candle | 5-10 | <1% |
| Free-standing candle | 11-20 | 3 to 35 |
| Shoe soles/insoles | 21-30 | -0- |
| Extruded articles | 31-95 | -0- |

The above table shows no possibility of adding an appreciable level of fragrance in the liquid gel or in container candle gels without going to a dangerous flash point level. But, the freestanding candle and even higher grades give a wide range of formulations as given in Table II.

Now the polymer candles made from Kalene of several grades are illustrated by several examples.

TABLE IV

| Kalene | Fragrance/Oil Blend | Flame Retardent | Antioxidant |
|---|---|---|---|
| 30 | 56.7% | 0.1% | 0.01% |
| 20 | 35.0% | 0.1% | 0.01% |
| 15 | 13.3% | 0.1% | 0.01% |

### EXAMPLE 1

98 parts by weight of Kraton G1650, 0.1 parts by weight of Polyethylene ACB, 1.0% of Engage, 0.1% of flame retardant, 0.01% of an antioxidant, 0.01% of an antistatic agent, and 0.08% of an antifoaming agent and blended together. This polymer blend is Kalene-100.

An oil blend is made by blending 20 parts by weight of Drakol-34 and 80 parts by weight of Semptol-350. This is hereinafter called oil blend SD82.

15 parts by weight of Kalene-100 and 85 parts by weight of oil blend SD82 are heated together at 298° F. for 4 hours for a 10 lb. batch. This is Kalene-15.

86.7 parts of Kalene-15 and 13.3 parts of fragrance/oil blend made according to Table I and heated together at 300° F. Colorants, glitter, and other decorative materials which do not catch fire as the flame works its way down the candle may be added, either before pouring or after pouring the melt into a mold.

The candle must be completely cool before taking it out of the mold.

### EXAMPLE 2

43.3 parts of Kalene-30 and 56.7 parts of oil blend are heated together to give a smooth molten mass. Since the oil blend contains the required amount of fragrance, no additional fragrance need be added.

### EXAMPLE 3

76.5 parts of Kalene-17 and 24.5 parts of oil blend are heated together to get a smooth melt. The melt is poured into a mold at about 800° F. and allowed to cool.

While the invention has been described in conjunction with specified embodiments, it is evident that many alternatives, modifications, and variations will be apparent to those skilled in the art in light of the forgoing descriptions and examples, and without deviating from the contemplated scope of the present invention. Accordingly, it is intended to embrace all such alternatives, modifications, and variations which fall within the spirit and scope of the appended claims.

Having thus described the invention, it is now claimed:

I claim:

1. A material described, as Plastoelastomeric Polymer comprised of at least one thermoplastic, at least one thermoplastic elastomer, and at least one elastomer and an oil.

2. The thermoplastic in claim 1 is selected from a group of polyethylenes such as LDPE, HDPE, LLDPE (which stand for Low Density Polyethylene, High Density Polyethylene, Linear Low Density Polyethylene), Polystyrenes, Polypropylene, Ethylene-propylene copolymer, polyamides.

3. The thermoplastic elastomer in claim 1 is selected from the group known as Kraton, Santoprenes, or Engages.

4. The elastomer in claim 1 is selected from the group containing polyisoprene, polybutadiene, EPDM, polybutylene, ethylene-octene copolymer, Engages.

5. The Kratons in claim 3 are selected from the Kraton D-series, G-series, diblock and optionally triblock, oil extended thermoplastic elastomers such as IR303.

6. An unbreakable, freestanding, transparent candle without the need for a container.

7. The candle in claim 6 is comprised of a body and a wick.

8. The body of the candle in claim 7 comprises Plastoelastomeric Polymer in claim 1 and hydrocarbon oil.

9. The body of the candle in claim 7 is comprised of at least one diblock copolymer having thermoplastic and elastomeric segments.

10. The body of the candle in claim 6 is comprised of 10.1 to 20 weight percent of solid components and 90 to 80 percent by weight of oil.

11. The plastoelastomeric material in claim 1 is comprised of thermoplastic components and clastomeric components as monoblocks, diblocks, or triblocks, wherein the proportions of thermoplastic phase to elastomeric phase are from 1 to 99 and from 99 to 1, preferably from 40 to 60 and from 60 to 40.

12. The candle in claim 6 comprises a body and a wick, wherein the said body is from 70 to 90 weight percent of an oil, liquid paraffin, plasticizer or extender, and about 10 to 30 weight percent of a thermoplastic, thermoplastic elastomer, and an elastomer as in claim 1.

13. The candle in claim 6 is comprised of a diblock copolymer and optionally a monoblock polymer or a triblock polymer or combinations thereof.

14. Shoe soles, insoles, heel cups, and other shoe components comprising Plastoelastomeric Polymer as in claim 1.

15. Prosthetics, body implants, explants, shoulder pads, bra inserts comprised of Plastoelastomeric Polymer claimed in 1.

16. Window insulating sheets comprising Plastoelastomeric Polymer claimed in 1.

17. The proportions of the solid component and oil component are from 10 to 90 or from 90 to 10.

18. The candle in claims 6, 14, 15 & 16 additionally contains a thermochromic dye.

19. The candle in claim 6, 14,15 & 16 additionally contains a photochromic dye.

20. The Plastoelastomeric Polymer in claim 1, additionally contains a thermochromic dye, a photochromic dye, a conventional dye, a fluorescent pigment, phosphorescent pigment, iridescent pigment, glitters, etc. or combinations thereof.
